(19) United States
(12) Patent Application Publication
(10) Pub. No.: US 2003/0177779 A1
(43) Pub. Date: Sep. 25, 2003

(54) Hi-efficient evaporator coil of flake ice making machine

(76) Inventor: Kee Voon Loke, Alor Setar (MY)

Correspondence Address: MERCHANT & GOULD PC, P.O. BOX 2903, MINNEAPOLIS, MN, 55402-0903, US

(21) Appl. No.: 10/391,539

(22) Filed: Mar. 17, 2003

(30) Foreign Application Priority Data
Mar. 22, 2002 (MY) PI 2002 1015

(51) Int. Cl. F25C 1/14; B67D 5/62

(52) U.S. Cl. 62/354; 62/399

(57) ABSTRACT

There is disclosed a flake ice-making machine for producing flake ice. The apparatus comprises a cylindrical evaporator (1), a water-flow distribution means (2) for introducing water to be frozen to flow downwardly in a thin sheet over the inner wall (14) of the evaporator (1) and an elongated ice-scraping means (4) mounted centrally inside the evaporator (1). Unlike conventional flaked ice maker, the flake ice maker of the present invention has an evaporator (1) that is provided with an expansion coil (3). To improve operating efficiency, the expansion coil (3) is further provided with a plurality of baffle (53).

### 1. TECHNICAL FIELD OF THE INVENTION

The present invention relates generally to an ice-making machine, and more particularly to a flake ice-making machine.

### 2. BACKGROUND OF THE INVENTION

Flake ice is being extensively used in food industry especially in marine industry where the catch is iced to preserve freshness while it is being transported to consumers. The flake ice is produced using flake ice-making machines which are rather common art these days. However existing flake ice-making machines have their drawbacks, some of which are listed below:

i. The conventional flooded type fresh water flake ice-making machine is too bulky and heavy because it must be operated together with a large sized liquid separator (which is actually a pressure vessel) which function is to separate the evaporation liquid and vapour ensuring no liquid flow-back to the compressor. Moreover the conventional flooded type of evaporator cylinder comprising an inner and an outer wall is in fact a pressure vessel. Being a pressure vessel, both the inner and outer walls have to be made of metal with great thickness to withstand high pressure. The bigger the diameter of the vessel (cylinder of larger capacity) the thicker is the metal required to withstand the refrigerant's high pressure at normal temperature (that is when the compressor is not in operation) and at a working temperature of approximately −25° C. which pressure would cause severe change in form to the vessel due to expansion (at high temperature) and shrinkage (at low temperature) of metal of insufficient thickness. Since the walls have to be made of very thick metal to withstand the high pressure, the heat conducting efficiency is greatly reduced. Thus the material chosen for the walls has to be very good heat conductors such as aluminium or copper but they are soft and not strong enough to withstand the high pressure leaving carbon steel as the best alternative. However carbon steel rusts easily affecting durability and resulting in poor hygiene in the long term. If carbon steel is replaced with a more durable and rust resistant material such as stainless steel, the freezing efficiency is very much reduced as stainless steel is a much poorer conductor than carbon steel. The inefficiency in freezing is further aggravated by the thickness of the stainless steel required in the conventional model engaging a pressurized vessel concept.

ii. To avoid the carbon steel from becoming rusty, the carbon steel surface of the inner wall of the cylinder of the conventional direct expansion internal type fresh water flake ice-making machines and the conventional flooded type fresh water flake ice-making machines is plated with a thin layer of chrome. However this not only increases manufacturing cost but is time consuming and tedious to manufacture and it does not last a lifetime as when the thin layer of chrome wears off due to the continuous ice scrapping force on the freezing surface, the carbon steel becomes exposed and is susceptible to rust.

iii. If sea water is to be frozen into flake ice using the conventional method, the manufacturer has no alternative but to use stainless steel as the walls of the evaporator cylinder since only first grade stainless steel is rust proof. In those circumstances a huge capacity compressor unit has to be employed to compensate for the low freezing efficiency thus increasing the cost of production.

iv. The oil that returns from the conventional flooded evaporator to the compressor also causes problems at times especially when the liquid level is not maintained properly by the level control or shortage of refrigerant due to leakage.

v. Liquid hammer—In the conventional model of top inlet and bottom outlet internal direct expansion flake ice-making machine, the shut down operation utilizes the liquid pump down system which ensures that no refrigerant remains in the evaporator when operation is resumed. However in the event of power failure, short circuit or other disturbances which causes the machine to cease operation abruptly without notice all the unevaporated refrigerant will settle and collect at the bottom outlet zone due to the force of gravity and upon the operation being resumed large amount of refrigerant in excess of the thermostatic expansion valve's response and the accumulator's handling capacity will surge back to the compressor at once causing severe damage to the valves and pistons of the gas compressor.

vi. The centrifugal force of the flowing refrigerant mixture in the direct expansion evaporator coil causes the refrigerant mixture to come into more contact with the outer walls of the expansion coil (3) leaving the inner walls (14) of the coil barely having much contact. This in turn causes poor heat exchange and evaporation on the inner walls of the cylinder (freezing surface much contact. This in turn causes poor heat exchange and evaporation on the inner walls of the cylinder (freezing surface for ice formation) which borders the inner wall of the expaporator coil and thus lowers productivity and efficiency of ice formation.

Due to these problems, the existing direct expansion internal type of fresh water flake ice-making machines have not been operating satisfactorily especially during abrupt stopping and resuming operation and more often less efficiently and are not durable and unhygienic besides being costly. The present invention therefore attempts to eliminate or at least minimize the aforesaid drawbacks. Some of the solutions proposed are summarized as below:

i. A significant feature of the present invention is the bottom refrigerant inlet direct expansion system (which can attain the evaporation efficiency in the evaporator coil as achieved in a semi-flooded evaporation system) where the exiting gas at the top outlet is fully evaporated and hence no liquid hammer problem that may damage the valves and pistons. This type of machine can overcome problems of abrupt halt as elaborated above.

ii. The present invention is able to use stainless steel cylinders as the freezing surface which can last a lifetime without having to compromise freezing efficiency as achieved in the conventional machines thus eliminating problems relating to rustiness and hygiene and enhances durability besides being cost effective. The fact that stainless steel is a poorer heat conductor as compared to carbon steel is immaterial as this is overcome by the use of baffles fixed in the square passages of the direct expansion coils which aids in directing the flow of the refrigerant to the required parts for more efficient evaporation.

iii. The baffles, the most significant feature of the present invention serves to deflect the flow of the refrigerant in the predetermined parts of the direct expansion evaporation coil thus directing the flow of the refrigerant towards the inner walls of the direct expansion evaporator coil absorbing heat instantly and in the process of evaporation freezes the inner cylinder (11) instantly. This in turn freezes the inner wall of evaporator (14) thereby creating a more efficient freezing surface for ice formation. The change in direction of flow also helps to push away refrigerant evaporating bubbles which form on the inner walls of the expansion evaporator coil and thus enhances heat exchange efficiency and faster evaporation.

iv. Alternatively the present flake ice-making machine can also utilize carbon steel with a thin layer of chrome plated surface [as in the conventional direct expansion internal type fresh water flake ice-making machine] fixed with baffles to attain an even much better freezing efficiency. As the present invention is not based on the concept of a pressurized vessel as in the conventional type of machine, the walls of the cylinder can be made of much thinner carbon steel in place of the thick walls required in the conventional flooded type of machine to withstand high pressure. The thinner walls further enhances better heat exchange rate thus providing better evaporation and more efficient formation of ice besides enabling a smaller, lighter and less costly flake ice-making machine to be achieved.

The introduction of the present solutions significantly reduces bulkiness and cost whilst increasing hygiene, the life span of the machine and the direct expansion evaporator coil cylinders and more importantly overall operating efficiency of the flake ice-making machine. With this present invention, it is hoped that the machine will be more durable and able to operate more satisfactorily and efficiently and therefore be more beneficial and cost effective to users.

### 3. SUMMARY OF THE INVENTION

Accordingly, it is the primary aim of the present invention to provide a new and novel flake ice-making machine that is devoid of the problems faced in prior art machines.

It is another object of the present invention to provide a flake ice-making machine that is less costly to acquire, less bulky and more simple to operate.

It is yet another object of the present invention to provide a flake ice-making machine that is of simple design for easy manufacture and operation.

It is yet another object of the present invention to provide a flake ice-making machine that has improved overall operating efficiency and increased productivity.

It is yet another object of the present invention to provide a flake ice-making machine that is hygienic and durable.

These and other objects of the present invention are achieved by,

A flake ice-making machine comprising;

A cylindrical evaporator (1) having an inner cylinder (11) and an outer cylinder (12) concentrically mounted to define therebetween a chamber (13), said evaporator having an inner wall (14);

a water-flow distribution means (2) for input of water to be frozen from the top to flow downwards and a water-flow distributing means for input of water to be frozen from the bottom and a pump to pump water to the top to the round water pan fixed with water distributors which function is to distribute water to the inner wall (14) of the said evaporator (1); and

an elongated ice-scrapping means (4) mounted centrally inside said evaporator (1),

characterized by

said evaporator (1) being provided with a direct expansion evaporation coil (3) which is formed by securely welding around the inner wall of the cylinder (11) with a number of circular metal plates and welding the opposite edge of the plates individually with a metal sheet covering all gaps wounding round the cylinder from top to bottom which end product is the outer wall of the cylinder (12) and a number of square passages (63) within the said chamber (13).

To further improve cooling efficiency, the direct expansion evaporation coil (3) refrigerant passage [square passage] is provided internally with a plurality of baffles (53) that deflect the direction of flow of the refrigerant to the inner wall of the direct expansion evaporation coil. The inner wall of the evaporator coil (3) is also the inner wall of the cylinder (14) that also acts as the freezing surface where flake ice is formed.

### 4. BRIEF DESCRIPTION OF THE DRAWINGS

Other aspect of the present invention and their advantages will be discerned after studying the Detailed Description in conjunction with the accompanying drawings in which:

FIG. 1 showing a cross-sectional side view of the flake ice-making machine according to one embodiment of the present invention.

FIG. 2 showing a cross-sectional top view of the flake ice-making machine's baffles in the square passage where refrigerant evaporate and flow.

### 5. DETAILED DESCRIPTION OF THE DRAWINGS

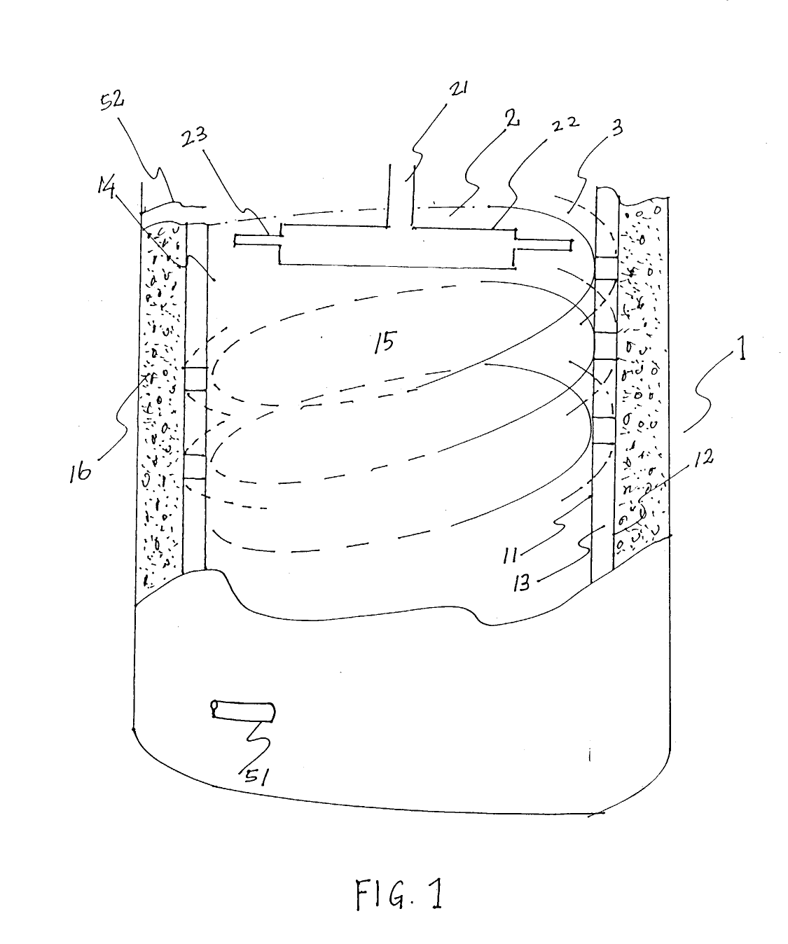

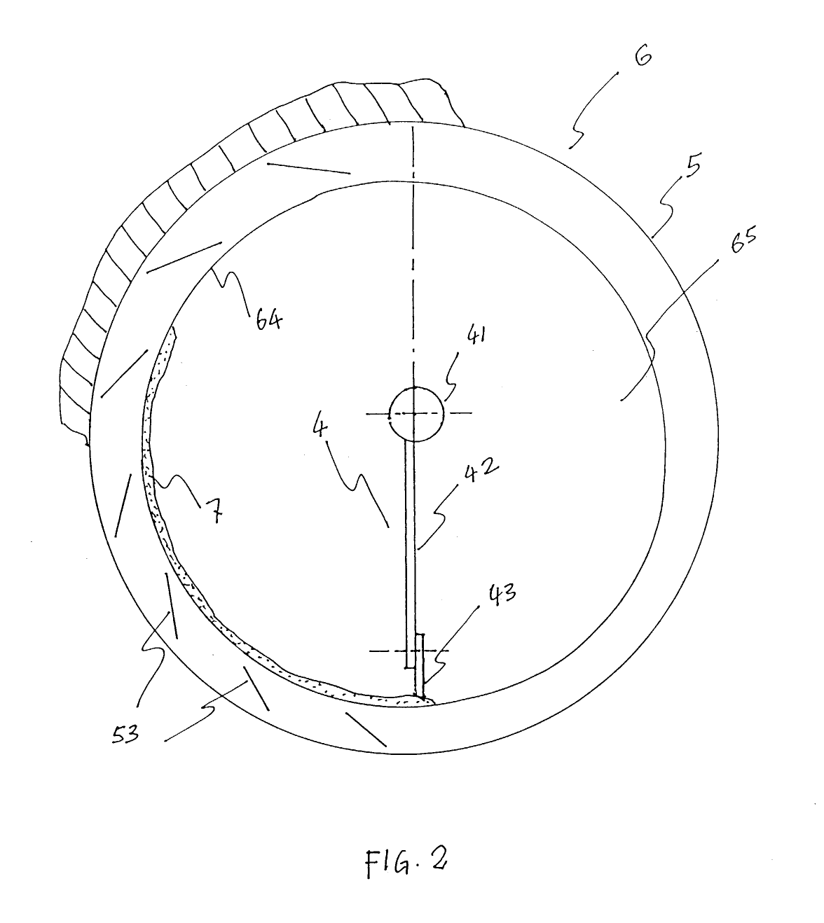

Referring now to FIG. 1 and FIG. 2 showing a cross sectional side view and top view of the flake ice-making machine according to one embodiment of the present invention. In the broadest aspect of the present invention, the flake ice-making machine comprises a cylindrical evaporator (1), a water-flow distribution means (2) and an elongated ice-scraping means (4).

The cylindrical evaporator (1) has an inner cylinder (11) and an outer cylinder (12) mounted concentrically to define there between a chamber (13). The inner wall of the cylinder becomes the inner wall of the evaporator (14) that serves as the freezing surface that is circular to define a freezing chamber (15). Advantageously, to preserve heat loss the evaporator (1) is insulated on the outside using any known insulating materials (16) such as polyurethane. Unlike conventional flake ice-making machine, the flake ice-making machine of the present invention has the evaporator (1) equipped with baffles fixed in the square passages of the direct expansion evaporator coil (3) concentrically mounted inside the chamber (13).

At the top section of the freezing chamber (15) a water-flow distribution means (2) is mounted. The water-flow distribution means (2) comprises a main shaft (21), a circular water pan (22) distribution pipes (23) evenly spaced apart angularly. In this way, water to be frozen is evenly introduced and counter flow downwardly with the rising refrigerant in a thin sheet over the inner wall (14) of the evaporator (1) for better heat exchange and hence a more efficient freezing.

The elongated ice-scraping means (4) comprises a spindle (41) mounted centrally inside the freezing chamber (15) of the evaporator (1), a holder (42) and an ice-scraping blade (43) is made from harden stainless steel. For easy maintenance and replacement, the blade (43) is detachably mounted onto the holder (42) which in turn is mounted onto the rotatable spindle (41). For purposes and hygiene and a longer life span with less maintenance, hardened stainless steel is chosen for the ice-scraping means (4).

FIG. 2 showing the baffles inside the square passages of the expansion evaporation coil is now referred. One of the more glaring flaw of the prior art flake ice-making machine that lends to a less efficient cooling is in the evaporator. The evaporator of the prior art machine comprises an inner cylinder and an outer cylinder to define an evaporating chamber. An inlet means and an outlet means are provided for introducing and exiting the refrigerant. The thick metal walls, the bigger sized and bulky flooded type of evaporating chamber that resisted heat exchange causes low refrigerant evaporation. Further the effect of the centrifugal force also causes more refrigerant to come into contact with the direct expansion evaporator's outer wall rather than the inner wall which lends to a less efficient cooling. In the present invention, a direct expansion type is preferred. To improve evaporation flow in the present system, the evaporator (6) is provided with an expansion coil (3) having an inlet means (51) at the bottom and an outlet means (52) at the top of the freezing chamber (65). The expansion evaporation coil (5) is concentrically fixed and welded forming a square passage (63) of the cylindrical evaporator (6).

To further improve cooling efficiency, a plurality of baffles (53) are provided in the expansion coil (3). The plurality of baffles (53) are evenly spaced apart at certain parts and inclined at a certain predetermined angle to direct flow of the refrigerant towards the freezing surface, that is the inner wall (64) of the evaporator (6). In principal, in the present invention, a square cross sectional expansion evaporation coil (3) is preferred for easy installation of the baffles.

Stainless steel is chosen as the material for the inner cylinder wall (3) and the baffle (53) due to its inherent rust resistant property thereby ensuring hygiene and is ever lasting.

Referring back to FIGS. 1 and 2, refrigerant entering the inlet means (51) at the bottom will flow upward to the outlet means (52) at the top. As the refrigerant flow upward, it is being deflected by the baffles (53) along the way to the inner wall (14) of the evaporator (1). This brings about two effects. Firstly, a direct expansion semi-flooded evaporation effect is achieved besides having better heat exchange efficiency, being more simple to operate and by being governed by a thermostatic expansion valve whereby the refrigerant leaving the top outlet means (52) is fully evaporated thus eliminating liquid hammer that may damage the valves and pistons of the compressor in the event that the operations of the machine is instantaneously halted. Secondly, due to the deflection of refrigerant flow to the inner wall (64), better contact and evaporation is achieved and there is now a much improved cooling effect, i.e. more formation of ice (7). Alternatively refrigerant can be introduced from the top to flow to the bottom but the efficiency is less as it is drier with less refrigerant inside due to the force of gravity. It was found out during field testing that a 15 H.P compressor unit flake ice-making machine using stainless steel cylinder without baffles produces 2300 kg/24 hr while another similar machine having the same power fitted with baffles produces 3000 kg/24 hr. A 15 H.P. conventional machine fitted with carbon steel chrome plated cylinder also produces 3000 kg/24 hr but it does not last long. While the preferred embodiment of the present invention and their advantages have been disclosed in the above Detailed Description, the invention is not limited thereto but only by the spirit and scope of the appended claim.

What is claimed is:

1. A flake ice-making machine comprising;
a cylindrical evaporator (1) having a stainless steel inner cylinder wall (11) and an outer wall of carbon or mild steel (12) concentrically mounted to define therebetween a chamber (13), said evaporator having an inner wall (14);
a water-flow distribution means (2) for introducing water to be frozen to flow downwardly in a thin sheet over said inner wall (14) of said evaporator (1); and
an elongated ice-scraping means (4) mounted centrally inside said evaporator (1),
characterized by
said evaporator (1) being provided with a direct expansion evaporation coil (3) spirally mounted inside said chamber (13).
Said expansion evaporating coil (3) having an inlet means (51) at the bottom and an outlet means (52) at the top of freezing chamber (65)

2. A flake ice-making machine as claimed in claim 1, further characterized by said expansion evaporation coil (3) being square in cross section.

3. A flake ice-making machine as claimed in claim 2, further characterized by said expansion evaporating coil (3) being provided with a plurality of baffles (53) at certain predetermined parts of the coil.

4. A flake ice-making machine as claimed in claim 3, further characterized by said plurality of baffle (53) being spaced apart at equal intervals.

5. A flake ice-making machine as claimed in claim 3, further characterized by said plurality of baffle (53) being inclined at predetermined angle with respect to wall of said expansion evaporating coil (3).

6. A flake ice-making machine as claimed in claim 2 or 3, further characterized by said expansion coil (3) and said baffle(53) being made from stainless steel.

7. A flake ice-making machine as claimed in claim 3, further characterized by said expansion coil (3) and said baffle (53) can be also made from carbon steel but with improvement in terms of reduced bulkiness of the flake ice-making machine resulting in being cost effective and space saving as a smaller lighter machine can be achieved besides having comparable efficiency as the conventional bulky and more costly machine.
